(19) United States
(12) Patent Application Publication
(10) Pub. No.: US 2026/0354574 A1
(43) Pub. Date: Nov. 12, 2026

(54) Collaboration Dome System

(71) Applicant: Google LLC, Mountain View, CA (US)

(72) Inventors: Shokofeh Darbari, San Luis Obispo, CA (US); Christine Jean Wu, San Francisco, CA (US)

(21) Appl. No.: 19/672,415

(22) Filed: May 8, 2026

Related U.S. Application Data
(60) Provisional application No. 63/803,320, filed on May 9, 2025.

(51) Int. Cl. A47B 21/04; A47B 3/10; H04R 1/32; H04R 7/12

(52) U.S. Cl. CPC A47B 21/04; A47B 3/10; H04R 1/323; H04R 1/326; H04R 7/127; A47B 2200/0043; A47B 2200/0071; A47B 2200/0079; A47B 2220/0091; A47B 2220/13; H04R 2307/201

(57) ABSTRACT

A collaboration dome system includes a stand, a tabletop, an audio component, an acoustic dome, and an acoustic reflector. The stand can comprise a base and an upwardly extending support arm. The tabletop can comprise an upper surface and a lower surface that is mounted to the base of the stand. The audio component can comprise speakers and can be mounted to the support arm and disposed within the acoustic reflector. The acoustic dome can comprise an inner surface and an outer surface mounted to the upper portion of the support arm. The acoustic reflector can comprise an inner surface oriented towards the upper surface of the tabletop and can be disposed in the inner surface of the acoustic dome. Further, the inner surface of the acoustic reflector can be parabolic and configured to reflect sound waves generated by the speakers towards the upper surface of the tabletop.

### CROSS-REFERENCE TO RELATED APPLICATION

The present application claims the benefit of United States Provisional Patent Application No. 63/803,320 filed May 9, 2025, the entirety of which is hereby incorporated by reference.

### FIELD

The present disclosure relates generally to a collaboration dome system that is configured to improve acoustic control in shared workspaces. In particular, the collaboration dome system uses materials and a structural configuration that can better control the transmission of sound.

### BACKGROUND

A contemporary workspace can include groups of people in close proximity to one another. As a result, workspaces that are designed for collaboration and efficiency can present significant challenges with acoustic disruption. For example, an open-plan office, with its lack of physical barriers, though intended to foster communication and teamwork, simultaneously exposes employees to a constant stream of auditory and visual distractions. Conversations, phone calls, and other communications can be overly intelligible to unintended listeners and impact concentration. Furthermore, the increasing reliance on technology in collaboration environments introduces new avenues for privacy breaches and disruption. Addressing these challenges can require an approach that is focused on balancing the interests of flexible workplace communication, the ability to focus in shared workspaces, and convenience.

### SUMMARY

Aspects and advantages of embodiments of the present disclosure will be set forth in part in the following description, or can be learned from the description, or can be learned through practice of the embodiments.

One example aspect of the present disclosure is directed to a collaboration dome system that includes a stand that can comprise a base and an upwardly extending support arm. A tabletop can comprise an upper surface and a lower surface. The tabletop can be mounted to the base of the stand. An audio component can comprise one or more speakers. The audio component can be mounted to an upper portion of the support arm. An acoustic dome can comprise an inner surface and an outer surface mounted to the upper portion of the support arm. Furthermore, an acoustic reflector can comprise an inner surface oriented towards the upper surface of the tabletop. The acoustic reflector can be disposed in the inner surface of the acoustic dome. The audio component can be disposed within the inner surface of the acoustic reflector. The inner surface of the acoustic reflector can be parabolic and configured to reflect sound waves generated by the one or more speakers towards the upper surface of the tabletop.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a side perspective view of an example collaboration dome system according to example embodiments of the present disclosure.

FIG. 2 depicts a side perspective view of an example collaboration dome and portions of a support arm according to example embodiments of the present disclosure.

FIG. 3 depicts a front perspective view of an example collaboration dome system according to example embodiments of the present disclosure.

FIG. 4 depicts a rear perspective view of an example collaboration dome system according to example embodiments of the present disclosure.

FIG. 5 depicts a top perspective view of an example collaboration dome system according to example embodiments of the present disclosure.

FIG. 6 depicts a top perspective view of sound zones corresponding to regions surrounding the collaboration dome system according to example embodiments of the present disclosure.

Reference numerals that are repeated across plural figures are intended to identify the same features in various implementations.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

As used herein, the terms "first," "second," and "third" may be used interchangeably to distinguish one component from another and are not intended to signify location or importance of the individual components. The terms "includes" and "including" are intended to be inclusive in a manner similar to the term "comprising." Similarly, the term "or" is generally intended to be inclusive (i.e., "A or B" is intended to mean "A or B or both").

Approximating language, as used herein throughout the specification and claims, is applied to modify any quantitative representation that could permissibly vary without resulting in a change in the basic function to which it is related. Accordingly, a value modified by a term or terms, such as "about," "approximately," and "substantially," are not to be limited to the precise value specified. In at least some instances, the approximating language may correspond to the precision of an instrument for measuring the value. For example, the approximating language may refer to being within a ten percent (10%) margin.

Though the terms “system,” “component,” and “device” are used to describe the disclosed technology, other embodiments and/or types of structures can be used. For example, the disclosed technology can be embodied as an assembly, an apparatus, or other form. Further, the structures described herein can be used as part of a method of making and/or using the disclosed technology.

In general, the present disclosure is directed to a collaboration dome system that can include features that improve containment of sound from audio devices. By improving the containment of sound from audio devices, the non-disruptive collaboration in a shared workspace can be increased and the overall distracting noise generated in the workplace can be reduced. The collaboration dome system uses an acoustic dome that includes an acoustic reflector that is configured to direct sound towards users seated below the collaboration dome, thereby reducing the volume of sound that is transmitted beyond the collaboration dome. Further, the collaboration dome system includes components that can be tilted from a horizontal position to a vertical position, which reduces the footprint of the system and facilitates transportation and storage of the system. For example, these features allow for the movement of the system through narrow passages and/or doorways. Further, the collaboration dome system can include wheels that allow for more efficient movement of the collaboration dome system from place to place.

The collaboration dome system can comprise a stand, a tabletop, an audio component, an acoustic dome, and/or an acoustic reflector. The stand can be used to support the tabletop, acoustic dome, and/or other components. For example, the stand can be used to support a display device and/or a camera that can be used during a video conference. The stand can comprise a base (e.g., a base that includes one or more legs that can stabilize the collaboration dome system) and an upwardly extending support arm from which an acoustic dome and audio component can be mounted. The collaboration dome system can also include a tabletop that is mounted to the base of the stand. The tabletop can be used as a surface for computing devices (e.g., laptops and/or smartphones) and/or for users to rest their arms on. The collaboration dome system includes an acoustic dome that can be mounted to the upper portion of the support arm. Disposed within the acoustic dome is an acoustic reflector that is parabolic (e.g., a parabolically shaped acoustic reflector) and configured to reflect sound waves towards the upper surface of the tabletop. The collaboration dome system can also include an audio component that can be disposed within the acoustic reflector and mounted to the stand (e.g., to an upper portion of the support arm) and can include speakers through which videoconferences and other audio can be played back. The collaboration dome system can also include additional audio-visual devices (e.g., microphones). For example, the additional audio-visual devices can be mounted to the tabletop or within the acoustic dome and can be used during a video conference.

The collaboration dome system can be configured to enhance communication and collaboration in a variety of environments. Further, the collaboration dome system integrates specially configured components to create an immersive and focused environment for videoconferencing, presentations, and other collaboration activities. As such, the disclosed technology allows users to conduct meetings and other activities that use audio in a manner that enhances the privacy of hybrid communications and enables greater flexibility in team-oriented workspaces. Additionally, the disclosed technology can reduce overall distracting noise in shared workspaces and can be easily transported and stored.

With reference to the figures, a collaboration dome system 100 will be described in accordance with example aspects of the present subject matter. As discussed in greater detail below, collaboration dome system 100 may include features for reducing the transmission of sound and improving the privacy of hybrid collaboration in a shared workspace. The collaboration dome system 100 may define a vertical direction V, a lateral direction L, and a transverse direction T. The vertical direction V, the lateral direction L, and the transverse direction T may be mutually perpendicular and form an orthogonal direction system.

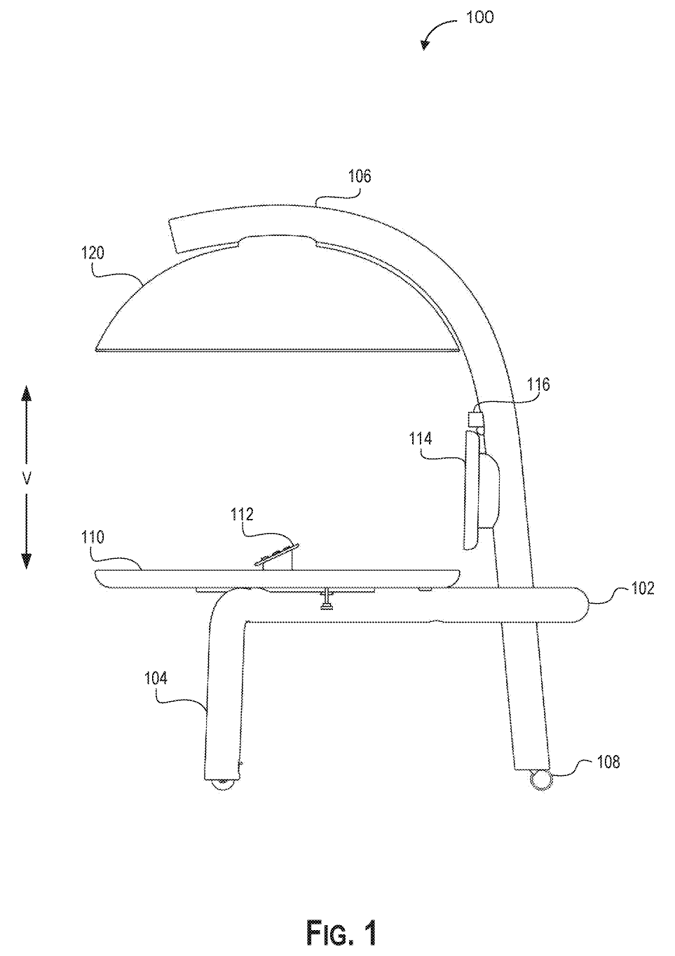

With reference to FIGS. 1-6, a collaboration dome system 100 may comprise a stand 102, a base 104, a support arm 106, wheels 108, a tabletop 110, a computing device 112, a display device 114, a camera 116, an acoustic dome 120, a sound-absorbing liner 122, an acoustic reflector 130, an audio component 140, an audio component mount 142, and/or one or more speakers 144.

As shown in FIG. 1, the stand 102 can be used as a support (e.g., a primary structural support) for the collaboration dome system 100. The stand 102 can be configured to support the tabletop 110, the acoustic dome 120, and other components which can include the display device 114 and/or the camera 116. The stand 102 can be configured to provide stability and appropriate positioning of other components of the collaboration dome system 100. Further, the stand 102 can be configured so that various components can be positioned in a preferred position. For example, the stand 102 can be used to position the display device 114 at an appropriate viewing angle, the camera 116 in a suitable position for video capture, and the acoustic dome 120 in a position that results in the preferred sound environment.

The stand 102 can comprise a base 104. Further, the base 104 can comprise one or more legs (e.g., one or more downwardly extending legs). For example, as shown in FIG. 1, one or more legs of the base 104 can extend downwards (e.g., downwards to a floor). Further, one or more of the one or more legs (e.g., one or more downwardly extending legs) of the base 104 can comprise one or more wheels 108. The one or more wheels 108 of the one or more legs of the base 104 can be used to transport the collaboration dome system 100 from one location to another location. For example, the collaboration dome system 100 can be moved from one conference room to another conference room or a storage room. The one or more wheels 108 can be constructed from durable materials including rubber and/or polyurethane. Further, the one or more wheels 108 can include one or more locking mechanisms to prevent the collaboration dome system 100 from rolling when it is in use. The wheels 108 can provide mobility and allow users to more easily reposition the collaboration dome system 100. Being able to easily reposition the collaboration dome system 100 can be useful in environments where space is limited or where the collaboration dome system is shared between multiple locations.

The stand 102 can be constructed from materials which can include steel, aluminum, wood, plastic, and/or reinforced composites to provide the strength and/or stability to support components of the collaboration dome system 100. The stand 102 can vary in height and design depending on the specific application and the desired user experience. The stand 102 may also incorporate adjustable features to accommodate different user heights and preferences. In some embodiments, the support arm 106 can be selectively movable. Further, the support arm 106 can be selectively movable relative to the tabletop 110 between a retracted configuration and an extended configuration. For example, the support arm 106 can be slidably adjustable such that a vertical height of the support arm 106 can be increased or decreased.

In some embodiments, the support arm 106 can be selectively movable by at least 20 centimeters between the retracted configuration and the extended configuration. For example, the support arm 106 can be raised 20 centimeters from an initial position. Further, the support arm 106 can be configured to support a device (e.g., a display device and/or a computing device). For example, the support arm 106 can comprise a support member (e.g., a bracket, hook, and/or magnet) that can support the display device 114, the camera 116, and/or the computing device 112.

The stand 102 can comprise the base 104. The base 104 can be configured to be the foundation of the stand 102 and provide stability to the collaboration dome system 100. For example, the base 104 can be configured (e.g., heavier weight in the lower portions of the base and/or a greater surface area of the base in contact with a floor or the ground) to prevent the collaboration dome system 100 from tipping over. The base 104 can be configured to distribute the weight of the collaboration dome system 100 evenly across a floor surface. For example, a four-legged base constructed of steel can provide a stable foundation for the stand 102, which can facilitate the collaboration dome system 100 remaining upright even when users lean on the tabletop 110 and/or adjust the display device 114. The base 104 can take various forms, which can include a circular disc, a multi-legged structure, or a weighted platform. The stand 102 can also include features including rubber feet and/or non-slip pads to prevent the stand 102 from sliding and/or scratching a floor beneath the base 104.

As shown in FIG. 1, the support arm 106 can extend upward from the base 104 of the stand 102 and can provide a mounting point for the acoustic dome 120 and/or the audio component 140. The support arm 106 can be configured to be strong (e.g., capable of bearing at least 5 times the combined mass of at least the acoustic dome 120, the sound-absorbing liner 122, the acoustic reflector 130, the audio component 140, the audio component mount 142, and the one or more speakers 144) and rigid, thereby promoting components including the acoustic dome 120 being held securely in place. In some embodiments, the support arm 106 may include cable management features to keep wires and cables organized and out of sight. For example, the support arm 106 can comprise cable management clips to keep power cables, video cables, and/or audio cables organized.

In some embodiments, the stand can have a height that is less than two meters. A height of less than two meters allows the stand 102 to be transported through standard doorways while in an upright configuration as shown in FIG. 1.

The tabletop 110 can provide a surface for users to place their computing devices (e.g., laptops, tablets, smartphones) and other materials. The tabletop 110 can also provide a place for users to rest their arms during meetings and/or presentations. The tabletop 110 can be constructed from a variety of materials, which can include steel, aluminum, plastic, wood, laminate, or glass. The tabletop 110 can be configured to be ergonomic and provide a comfortable and functional workspace. In some embodiments, the tabletop 110 can be pivotally adjustable relative to the base between a horizontal position that is substantially parallel to the lower edge of the acoustic dome 120 and a vertical position that is substantially perpendicular to the acoustic dome 120. For example, the tabletop 110 can be adjusted from a substantially horizontal configuration (e.g., a horizontal configuration that can be used to support objects and be used as a desk) to a substantially vertical configuration that can be used during transportation and which can occupy a smaller footprint when moving through doors and/or other narrow passageways. In some embodiments, a diameter or width of the tabletop 110 can be greater than a diameter or width of the acoustic reflector 130.

The computing device 112 (e.g., a laptop computing device, a desktop computing device, a tablet computing device, or a smartphone) can be connected (e.g., via a wireless connection or wired connection) to the collaboration dome system 100. The computing device 112 can comprise one or more processors, memory, a network device (e.g., a network device that can be used to wirelessly transmit data comprising audio data), and/or one or more storage devices. Further, the computing device 112 can be configured to generate data (e.g., audio data) that can be sent to the collaboration dome system 100, which can generate audio output (e.g., sounds including speech and/or music) via the audio component 140 which comprises one or more speakers. For example, the computing device 112 can run software including video conferencing software, presentation software, and/or sharing software that is used to transmit audio via the audio component 140 of the collaboration dome system 100.

The display device 114 can be used to display video and other visual content to users of the collaboration dome system 100. The display device 114 can comprise a monitor, a projector, and/or a large-format display. The display device can comprise a high resolution (e.g., 4K) display that can provide a clear and comfortable viewing experience for users. Further, the display device 114 can comprise features including touch screen capabilities that can be used for interactive presentations. The display device 114 can be configured to be mounted on the stand 102.

The camera 116 can capture video of users of the collaboration dome system 100 and transmit the video to remote locations (e.g., other buildings or meeting rooms). The camera 116 can be mounted on the stand 102 and/or the display device 114. The camera 116 can have a high resolution (e.g., 50 megapixels) and/or wide field of view (e.g., a field of view greater than 85 degrees horizontally and vertically) that can capture images of users seated around the collaboration dome system 100. Further, the camera 116 can include features like pan, tilt, and/or zoom capabilities for adjusting the framing of the video.

The acoustic dome 120 can be configured to absorb sound waves including the sound waves generated by the audio component 140. Reducing the sound waves generated by the audio component 140 can create a more focused audio environment, which can reduce distractions for individuals around the collaboration dome system 100 who are not users of the collaboration dome system 100. The acoustic dome 120 can be mounted to the stand 102. Further, the acoustic dome 120 can house the acoustic reflector 130 and/or the audio component 140. In some embodiments, the acoustic dome can comprise one or more lighting elements (e.g., one or more light emitting diodes (LEDs)) that can be used to illuminate the tabletop 110 and the area immediately surrounding the collaboration dome system 100. As shown in FIG. 1, the acoustic dome is a curved structure that can be positioned above the heads of users that are seated at the tabletop 110 of the collaboration dome system 100.

The acoustic dome 120 can be constructed from lightweight materials which can result in an overall reduction in the weight of the collaboration dome system 100 and facilitate its transportation. For example, the outer surface of the acoustic dome 120 can be constructed from acrylic or polycarbonate. The acoustic dome 120 can be configured to isolate the sound within the collaboration dome system 100, thereby reducing noise pollution that disturbs others in the workspace and improving the clarity of audio communications.

In some embodiments, the acoustic dome 120 can have a diameter or width in a range between 120 centimeters and 140 centimeters. A diameter or width of the acoustic dome 120 that is in the range between 120 centimeters and 140 centimeters can improve the sound containment and sound quality of sound waves emitted by the audio component 140. Further, the acoustic dome 120 can have a height in a range between 50 centimeters and 60 centimeters. A height of the acoustic dome 120 that is in the range between 50 centimeters and 60 centimeters can improve the sound containment and sound quality of sound waves emitted by the audio component 140.

An inner surface of the acoustic dome 120 can comprise a sound-absorbing liner. The sound-absorbing liner 122 can be mounted on an inner surface (e.g., a surface of the acoustic dome 120 that is positioned towards and/or faces the acoustic reflector 130). The sound-absorbing liner can comprise a layer of material (e.g., fabric) that is applied (e.g., glued, sewn, or fastened) to the inner surface of the acoustic dome 120. The sound-absorbing liner 122 can be configured to absorb sound waves, reduce echoes, and/or improve the audio quality for users of the collaboration dome system 100. Further, the sound-absorbing liner can be constructed from a variety of materials, which can include acoustic foam, felt (e.g., felt that includes wool), viscose, and/or other fabrics. Further, the sound-absorbing liner 122 can be configured based on its ability to absorb sound waves across a wide range of frequencies.

In some embodiments, the sound-absorbing liner can have a density in a range between 250 grams per cubic decimeter and 400 grams per cubic decimeter. Further, the sound-absorbing liner can have a thickness in a range between 5 millimeters and 20 millimeters.

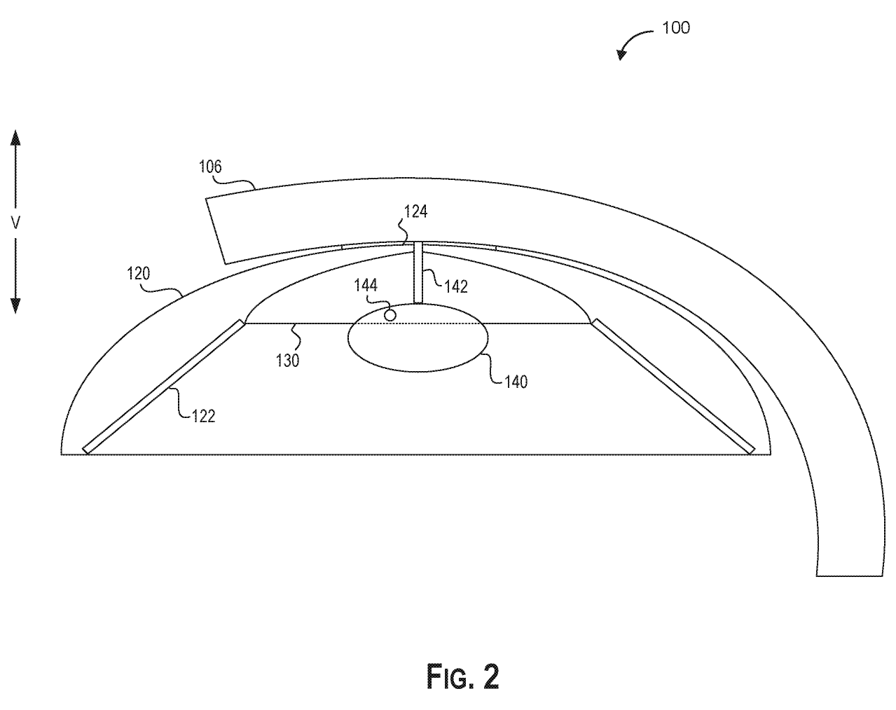

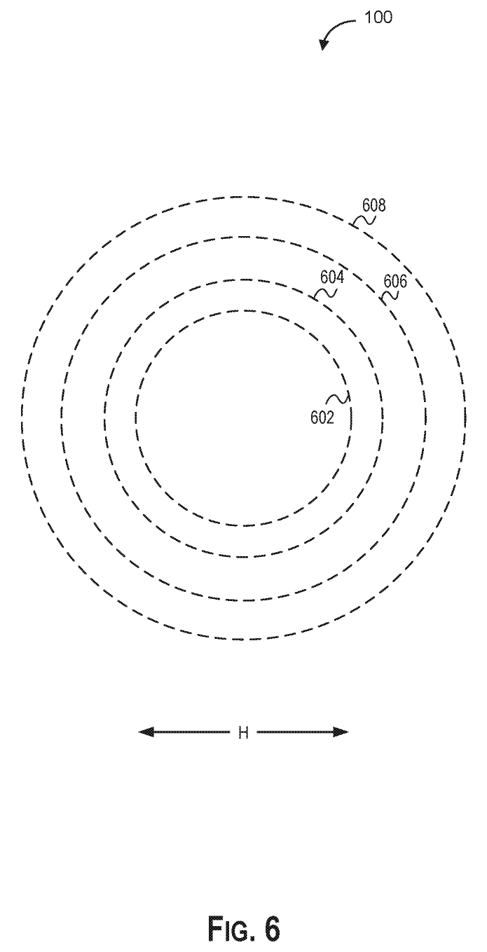

The acoustic dome 120 can be configured in a variety of shapes. The acoustic dome 120 can have a more polygonal (e.g., square shape, rectangular shape, hexagonal shape, or octagonal shape) shape. A square shape or rectangular shape of the acoustic dome 120 can allow for improved storage and/or can make the acoustic dome 120 more readily stackable. Further, the acoustic dome 120 can have a shape that is elliptical. As shown in FIGS. 1-4, the acoustic dome 120 can have a shape that is substantially elliptical in the vertical direction. As shown in FIG. 5, the acoustic dome 120 can have a shape that is substantially elliptical in the lateral direction and the transverse direction. Further, the tabletop 110 and/or the acoustic reflector 130 can have a variety of shapes (e.g., polygonal, or elliptical which can include circular) including a shape that matches or is substantially similar to the shape of the acoustic dome 120. For example, if the acoustic dome 120 has an elliptical (e.g., circular) shape in the lateral direction and transverse direction, the tabletop 110 and/or the acoustic reflector 130 can have a similar shape in the lateral direction and transverse direction. For example, the acoustic reflector 130 can have an elliptical shape and the acoustic dome 120 can also have an elliptical shape. In the vertical dimension, the acoustic reflector 130 can have a shape that is parabolic. As shown in FIG. 2, the acoustic reflector 130 can have a shape that is substantially parabolic in the vertical dimension.

In some embodiments, the acoustic dome 120 can be pivotally adjustable relative to the base between a horizontal position that is substantially parallel to the tabletop 110 and a vertical position that is substantially perpendicular to the tabletop 110. For example, the acoustic dome 120 can be adjusted from a substantially horizontal configuration (e.g., a horizontal configuration that is over the heads of users seated at the collaboration dome system 100) to a substantially vertical configuration that can be used during transportation, and which can occupy a smaller footprint when moving through doors and/or other narrow areas.

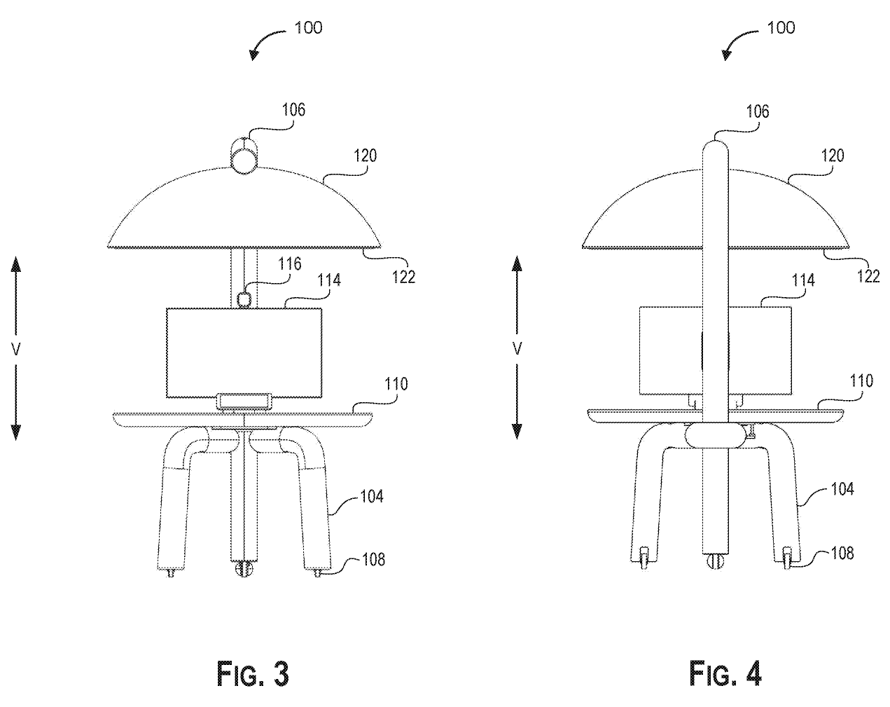

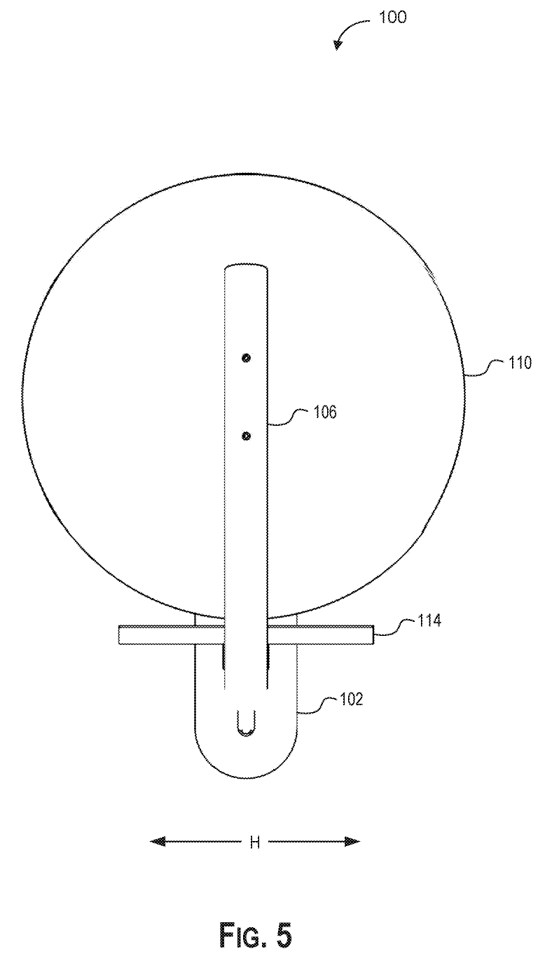

In some embodiments, a lower edge of the acoustic dome 120 can be in a range of 65 centimeters to 75 centimeters above the upper surface of the tabletop. For example, as shown in FIG. 3 and FIG. 4, the lower edge of the acoustic dome 120 that faces the upper surface of the tabletop 110 can be a distance of 70 centimeters from the upper surface of the tabletop 110 that is oriented towards the acoustic dome 120. Such a distance between the acoustic dome 120 and the tabletop 110 can improve the quality of audio that is transmitted to users of the collaboration dome system 100.

The acoustic reflector 130 can be used to reflect sound that is generated by the audio component 140. The acoustic reflector 130 can enhance the sound quality and directionality within the collaboration dome system 100 which can result in a more engaging and immersive audio experience. For example, the parabolic (e.g., vertically parabolic) shape of the acoustic reflector 130 can be used to direct sound waves from the audio component 140 towards users seated around the tabletop 110, thereby creating a more focused and immersive audio experience during a video conference.

The acoustic reflector 130 can comprise a parabolically-shaped device that is disposed within the acoustic dome 120 (e.g., the acoustic reflector 130 can be disposed in an inner surface of the acoustic dome 120). The acoustic reflector 130 can be configured to reflect sound waves generated by the audio component 140 towards the upper surface of the tabletop 110 and/or not towards other areas. By directing sound from the audio component 140 downwards towards the tabletop 110, users seated at the tabletop 110 can hear the sound more clearly. The acoustic reflector 130 can be vertically parabolic (e.g., a parabolic shape that has a vertical axis that is substantially perpendicular to the tabletop 110). The acoustic reflector 130 can have a diameter that is greater in the portions of the acoustic reflector 130 that are closer to the tabletop 110 than a diameter in the portions of the acoustic reflector 130 that are closer to the support arm 106. Further, the sound isolating features of the acoustic reflector can result in less sound leaking into areas around the collaboration dome system 100. The acoustic reflector 130 can be constructed from a rigid and sound-reflective material including steel, aluminum, plastic, or wood. The parabolic (e.g., vertically parabolic) shape of the acoustic reflector 130 is configured to focus sound waves and direct the sound waves towards the tabletop 110 and users seated around the tabletop 110.

In some embodiments, the acoustic reflector 130 can have a diameter or width in a range between 55 centimeters and 65 centimeters. A diameter or width of the acoustic reflector 130 that is in the range between 55 centimeters and 65 centimeters can improve the sound containment and sound quality of sound waves emitted by the audio component 140. Further, the acoustic reflector 130 can have a height in a range between 10 centimeters and 14 centimeters. A height of the acoustic reflector 130 that is in the range between 10 centimeters and 14 centimeters can improve the sound containment and sound quality of sound waves emitted by the audio component 140.

In some embodiments, the acoustic reflector 130 can be disposed in a central portion of the acoustic dome 120. For example, as shown in FIG. 2, the acoustic reflector 130 can be disposed in a substantially central portion of the acoustic dome 120.

The audio component 140 can be configured to generate audio including sound waves that are emitted during videoconferences, presentations, and other collaboration activities. The audio component 140 can comprise one or more speakers, one or more microphones, and/or one or more amplifiers. In some embodiments, the audio component 140 can comprise noise cancelling microphones and/or an echo suppression system that can be used to improve the audio quality in noisy environments. The audio component mount 142 can be used to mount the audio component 140 to the stand 102, the acoustic dome 120, and/or the acoustic reflector 130. In some embodiments the audio component 140 can be mounted directly to the stand 102, the acoustic dome 120, and/or the acoustic reflector 130. The audio component mount can be used to secure the audio component 140 in place. In some embodiments, the audio component 140 can comprise one or more light elements (e.g., one or more LEDs and/or one or more bulbs comprising one or more LEDs) and/or one or more microphones (e.g., one or more beamforming microphones).

Further, in some embodiments, an audio component mount 142 can be used to adjust a position of the audio component 140. For example, a height of the audio component 140 can be adjusted so that the audio component 140 is closer or further from the tabletop 110. In some embodiments, the audio component 140 can be disposed in a central portion of the acoustic reflector 130. For example, as shown in FIG. 2, the audio component 140 can be disposed in a substantially central portion of the acoustic reflector 130 that is substantially in the center of the acoustic reflector 130.

The audio component 140 can comprise one or more speakers 144 that are mounted in an upper portion of the audio component, oriented towards an upper surface of the acoustic reflector, and/or aligned with a lower edge of the acoustic reflector. For example, as shown in FIG. 2, the one or more speakers 144 are mounted in an upper portion of the audio component 140, oriented towards the top of the acoustic reflector 130, and aligned with the lower edge of the acoustic reflector 130. Such a configuration of the audio component 140 can improve the quality of sound that is transmitted to users of the collaboration dome system 100.

In some embodiments, the audio component 140 and/or one or more speakers of the audio component 140 can be oriented towards the tabletop 110 and at least ten centimeters from an uppermost portion of the acoustic dome 120. For example, in FIG. 2 the audio component 140 can be at least ten centimeters from the region 124 which is the uppermost portion of the acoustic dome 120.

FIG. 6 depicts a top perspective view of sound zones corresponding to regions surrounding the collaboration dome system according to example embodiments of the present disclosure. Further, the region 604 corresponds to the region covered by the tabletop 110 and also includes the region 602. When sound is being emitted by the audio component 140, the acoustic reflector 130 can be configured to reflect the sound to the regions 602-606. Within the regions 602-606 the audio quality can be high (e.g., easily understood without excessive volume). The region 606 can extend 20-40 centimeters beyond the perimeter of the region 604. Between the region 606 and the region 608 (e.g., the perimeter of the region 608 can extend 100-140 centimeters beyond the perimeter of the region 606), the volume of audio generated by the audio component 140 can be at an intermediate level of loudness. Further, beyond the region 608, the volume of audio generated by the audio component 140 can be at a low level of loudness that can minimize the disturbance of individuals that are not using the collaboration dome system 100.

The collaboration dome system is a versatile technology that is configured to improve communication and collaboration in a variety of environments. Each component of the collaboration dome system can contribute to creating an immersive, focused, and effective environment for virtual meetings, video conferences, presentations, and other collaboration activities. The stand, base, and support arm provide solid structural support and stability. Further, the wheels and foldable tabletop facilitate portability and storage. The collaboration dome system can be integrated with computing devices, display devices, microphones, and/or cameras that enable video conferencing and content sharing. Additionally, the acoustic dome, sound-absorbing liner, and acoustic reflector can work together to create a focused and high-quality audio environment. Further, the audio component and its mount ensure clear and natural-sounding audio playback. Through seamless integration of these components, the collaboration dome system can improve communication and collaboration.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

The attached Appendix, which is fully incorporated into and forms a portion of this disclosure, describes example implementations of the systems and devices described herein. The present disclosure is not limited to the example implementations described in the attached Appendix.

What is claimed is:

1. A collaboration dome system comprising:
a stand comprising a base and an upwardly extending support arm;
a tabletop comprising an upper surface and a lower surface, wherein the tabletop is mounted to the base of the stand;
an audio component comprising one or more speakers, wherein the audio component is mounted to an upper portion of the support arm;
an acoustic dome comprising an inner surface and an outer surface mounted to the upper portion of the support arm; and
an acoustic reflector comprising an inner surface oriented towards the upper surface of the tabletop is disposed in the inner surface of the acoustic dome, wherein the audio component is disposed within the acoustic reflector, and wherein the inner surface of the acoustic reflector is parabolic and configured to reflect sound waves generated by the one or more speakers towards the upper surface of the tabletop.

2. The collaboration dome system of claim 1, wherein the acoustic dome has a diameter in a range between 120 centimeters and 140 centimeters, and wherein the acoustic dome has a height in a range between 50 centimeters and 60 centimeters.

3. The collaboration dome system of claim 1, wherein the acoustic reflector has a diameter in a range between 55 centimeters and 65 centimeters, and wherein the acoustic reflector has a height in a range between 10 centimeters and 14 centimeters.

4. The collaboration dome system of claim 1, wherein a diameter of the tabletop is greater than a diameter of the acoustic reflector.

5. The collaboration dome system of claim 1, wherein the acoustic reflector is disposed in a central portion of the acoustic dome.

6. The collaboration dome system of claim 1, wherein the one or more speakers are mounted in an upper portion of the audio component, oriented towards the inner surface of the acoustic dome, and aligned with a lower edge of the acoustic reflector.

7. The collaboration dome system of claim 1, wherein the inner surface of the acoustic dome comprises a sound-absorbing liner.

8. The collaboration dome system of claim 7, wherein the sound-absorbing liner has a density in a range between 250 grams per cubic decimeter and 400 grams per cubic decimeter.

9. The collaboration dome system of claim 7, wherein the sound-absorbing liner has a thickness in a range between 5 millimeters and 20 millimeters.

10. The collaboration dome system of claim 1, wherein the support arm is selectively movable relative to the tabletop between a retracted configuration and an extended configuration.

11. The collaboration dome system of claim 10, wherein the support arm is selectively movable by at least 20 centimeters between the retracted configuration and the extended configuration.

12. The collaboration dome system of claim 1, wherein the support arm is configured to support a display device or a computing device.

13. The collaboration dome system of claim 1, wherein a lower edge of the acoustic dome is in a range of 65 centimeters to 75 centimeters above the upper surface of the tabletop.

14. The collaboration dome system of claim 1, wherein the audio component is disposed in a central portion of the acoustic reflector.

15. The collaboration dome system of claim 1, wherein the stand has a height of less than two meters.

16. The collaboration dome system of claim 1, wherein the acoustic dome or the acoustic reflector is substantially elliptical.

17. The collaboration dome system of claim 1, wherein the audio component further comprises one or more microphones.

18. The collaboration dome system of claim 1, wherein the one or more speakers of the audio component are oriented towards the tabletop and at least ten centimeters from an uppermost portion of the acoustic dome.

19. The collaboration dome system of claim 1, wherein the tabletop is pivotally adjustable relative to the base between a horizontal position that is substantially parallel to the acoustic dome and a vertical position that is substantially perpendicular to the acoustic dome.

20. The collaboration dome system of claim 1, wherein the base comprises one or more downwardly extending legs, and wherein each leg of the one or more downwardly extending legs comprises one or more wheels.
